(19) United States
(12) Patent Application Publication
(10) Pub. No.: US 2016/0323390 A1
(43) Pub. Date: Nov. 3, 2016

(54) CONDITION-BASED ONLINE COMMUNICATION COLLABORATION

(71) Applicant: International Business Machines Corporation, Armonk, NY (US)

(72) Inventors: Jiu Zheng Han, Beijing (CN); Qining Li, Beijing (CN); Yi Xu Song, Beijing (CN); Shuang Yu, Beijing (CN)

(21) Appl. No.: 14/698,984

(22) Filed: Apr. 29, 2015

(51) Int. Cl. H04L 29/08; H04L 12/26

(52) U.S. Cl. CPC H04L 67/16; H04L 43/04; H04L 67/306

(57) ABSTRACT

A method for generating and discovering online communication groups based on at least one condition is provided. The method may include collecting user real-time data. The method may also include initiating first online communication groups, wherein a user is enabled to specify conditions associated with the collected user real-time data. The method may further include applying the specified conditions to the first online communication groups. Additionally, the method may include initiating second online communication groups. The method may also include clustering conditions associated with the collected user real-time data, wherein the clustered conditions are applied to the second online communication groups. The method may further include generating the first and second online communication groups based on the specified and clustered conditions. The method may also include enabling user discovery of the first and second online communication groups based on whether the user matches the specified and clustered conditions.

### BACKGROUND

The present invention relates generally to the field of computing, and more specifically, to online communication.

Online communication has become a popular means for individuals to interact. For example, participants in online communities and conferences may engage in discussions, comment on various topics, share opinions, and collaborate on different projects and events. Online communication tools that are generally used include chat rooms, forums, social networking sites and messaging apps. Typically, one or more individuals may initiate online communications by directly contacting other individuals or adding those individuals to an already created group. Additionally, individuals may join online groups by specifically searching for the group names.

### SUMMARY

A method for generating and discovering online communication groups based on at least one condition is provided. The method may include collecting a plurality of user real-time data. The method may also include initiating a plurality of first online communication groups, wherein a user is enabled to specify a plurality of conditions associated with the collected plurality of user real-time data. The method may further include applying the plurality of specified conditions to the plurality of first online communication groups. Additionally, the method may include initiating a plurality of second online communication groups. The method may also include clustering a plurality of conditions associated with the collected user real-time data, wherein the plurality of clustered conditions are applied to the plurality of second online communication groups. The method may further include generating the plurality of first online communication groups based on the plurality of specified conditions. The method may also generating the plurality of second online communication groups based on the plurality of clustered conditions. The method may also include enabling user discovery of the plurality of first online communication groups and the plurality of second online communication groups, wherein the user discovery is based on whether the user matches the plurality of specified conditions and the plurality of clustered conditions associated with the collected user real-time data.

A computer system for generating and discovering online communication groups based on at least one condition is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include collecting a plurality of user real-time data. The method may also include initiating a plurality of first online communication groups, wherein a user is enabled to specify a plurality of conditions associated with the collected plurality of user real-time data. The method may further include applying the plurality of specified conditions to the plurality of first online communication groups. Additionally, the method may include initiating a plurality of second online communication groups. The method may also include clustering a plurality of conditions associated with the collected user real-time data, wherein the plurality of clustered conditions are applied to the plurality of second online communication groups. The method may further include generating the plurality of first online communication groups based on the plurality of specified conditions. The method may also generating the plurality of second online communication groups based on the plurality of clustered conditions. The method may also include enabling user discovery of the plurality of first online communication groups and the plurality of second online communication groups, wherein the user discovery is based on whether the user matches the plurality of specified conditions and the plurality of clustered conditions associated with the collected user real-time data.

A computer program product for generating and discovering online communication groups based on at least one condition is provided. The computer program product may include one or more computer-readable storage devices and program instructions stored on at least one of the one or more tangible storage devices, the program instructions executable by a processor. The computer program product may include program instructions to collect a plurality of user real-time data. The computer program product may also include program instructions to initiate a plurality of first online communication groups, wherein a user is enabled to specify a plurality of conditions associated with the collected plurality of user real-time data. The computer program product may further include program instructions to apply the plurality of specified conditions to the plurality of first online communication groups. Additionally, the computer program product may include program instructions to initiate a plurality of second online communication groups. The computer program product may also include program instructions to cluster a plurality of conditions associated with the collected user real-time data, wherein the plurality of clustered conditions are applied to the plurality of second online communication groups. The computer program product may further include program instructions to generate the plurality of first online communication groups based on the plurality of specified conditions. The computer program product may also program instructions to generate the plurality of second online communication groups based on the plurality of clustered conditions. The computer program product may also include program instructions to enable user discovery of the plurality of first online communication groups and the plurality of second online communication groups, wherein the user discovery is based on whether the user matches the plurality of specified conditions and the plurality of clustered conditions associated with the collected user real-time data.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is a block diagram illustrative of one embodiment of a program for generating and discovering online communication groups based on at least one condition;

FIG. 3 is an operational flowchart illustrating the steps carried out by a program for generating and discovering online communication groups based on at least one condition;

FIG. 4 is a block diagram of the system architecture of a program for generating and discovering online communication groups based on at least one condition;

FIG. 5 is a block diagram of an illustrative cloud computing environment including the computer system depicted in FIG. 1, in accordance with an embodiment of the present disclosure; and

FIG. 6 is a block diagram of functional layers of the illustrative cloud computing environment of FIG. 5, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

Embodiments of the present invention relate generally to the field of computing, and more particularly, to online communication. The following described exemplary embodiments provide a system, method and program product for discovering online communications and participating in online communications based on one or more conditions. Therefore, the present embodiment has the capacity to improve the technical field of online communication by allowing users to initiate online communications and join online communications based on specified conditions. More specifically, online communications may be generated, discovered, and joined by users based on rules and conditions specified by users and a program, and associated with real-time data collected by the program.

As previously described with respect to online communications, one or more individuals may initiate a group communication by directly contacting and adding participants to the communication. Furthermore, participants may individually join group communications by directly searching for the names of the group communications. For example, an online group discussion based on an instant messaging app may require the group initiator to specify the group participants explicitly. Therefore, the personal information of the specified group participants may have to be known to the group initiator. Additionally, users who want to join online discussions and group communities on websites may first need to search for the groups using the exact group names or names deemed similar to the exact group names by the system, or else the search may result in no groups or different groups than expected by the search. Thus, current methods may restrict user access to online communications of interest to the users. As such, it may be advantageous, among other things, to provide a system, method and program product for generating and discovering online communications based on one or more conditions.

According to at least one embodiment of the present invention, online communications may be generated, discovered, and joined based on rules and conditions. In one embodiment, user real-time data may be collected. Furthermore, according to one implementation, online communication groups may be user-initiated and program-initiated. Also, according to one implementation, rules and conditions may be implemented to restrict users from discovering and joining the online communication groups. Additionally, conditions may be inputted by users to match users to the online communication groups that the users may be eligible for based on the collected real-time data and the specified rules and conditions. Then, according to one implementation, the list of the online communication groups may be ranked and presented to the users.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for generating and discovering online communication groups based on at least one condition.

According to at least one implementation, real-time data on users may be collected. Furthermore, online communication groups may be initiated by users as well as by a program, such as a condition-based communication program. Additionally, conditions for discovering and joining the online communication groups may be specified by a user. Also, the condition-based communication program may cluster conditions to initiate the online communication groups based on the real-time data collected on users. Then, rules may be implemented to restrict users' accessibility to the online group communications based on the received conditions. Thereafter, the specified conditions and the clustered conditions may be received, and the online communication groups may be generated. Next, the online communication groups may be discoverable and joined by the users matching the rules and conditions. Furthermore, users may be presented a list of the online communication groups that the users are eligible for by inputting conditions that match the conditions of the online communication groups. Additionally, the list of the online communication groups may be ranked. Furthermore, users may be enabled to discover and join the online communication groups based on the rules and conditions associated with the collected user real-time data.

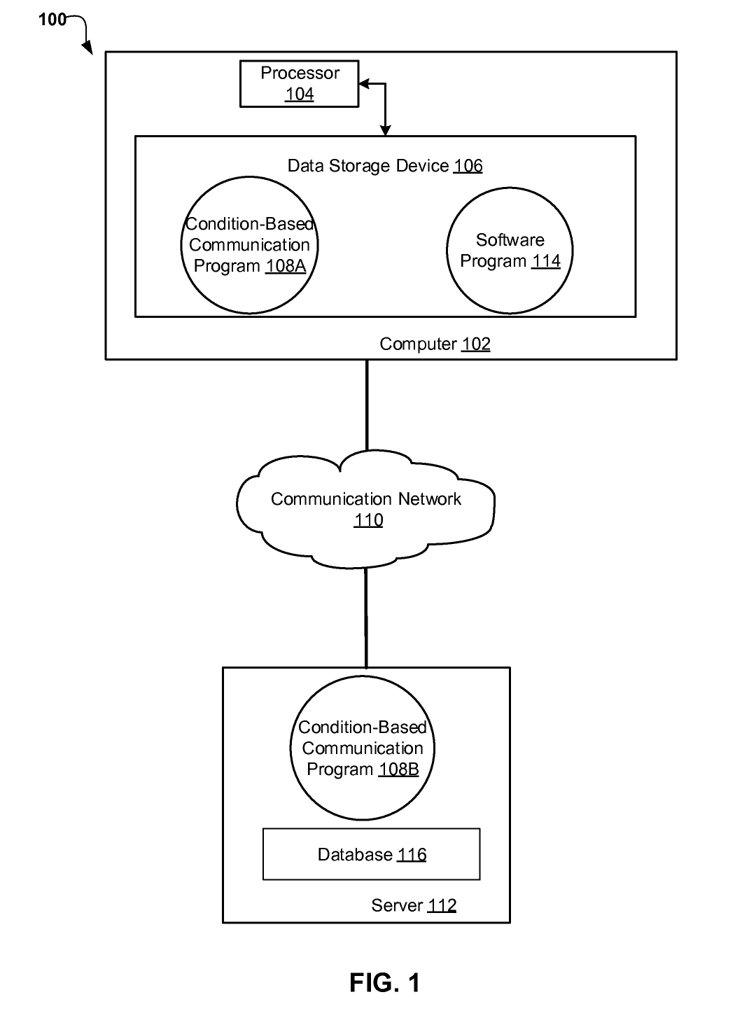

Referring now to FIG. 1, an exemplary networked computer environment 100 in accordance with one embodiment is depicted. The networked computer environment 100 may include a computer 102 with a processor 104 and a data storage device 106 that is enabled to run a condition-based communication program 108A and a software program 114. The software program 114 may be an application program such as an internet browser and an email program. The condition-based communication program 108A may communicate with the software program 114. The networked computer environment 100 may also include a server 112 that is enabled to run a condition-based communication program 108B and a communication network 110. The networked computer environment 100 may include a plurality of computers 102 and servers 112, only one of which is shown for illustrative brevity.

According to at least one implementation, the present embodiment may also include a database 116, which may be running on server 112. The communication network may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

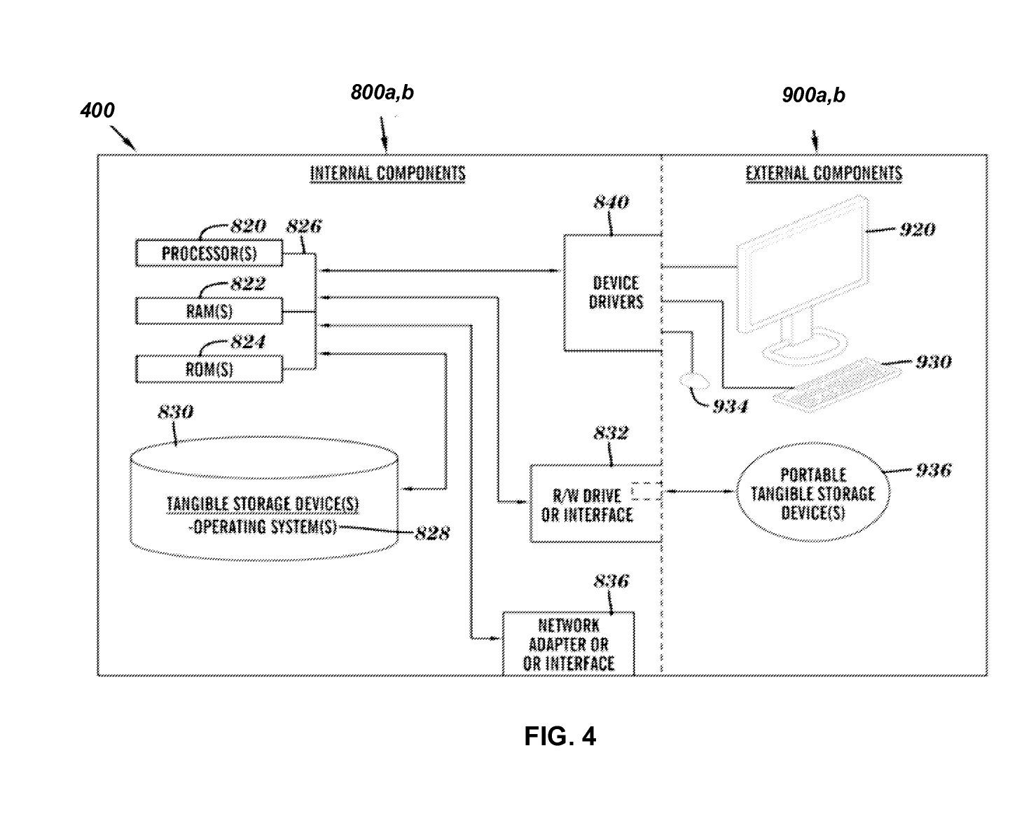

The client computer 102 may communicate with server computer 112 via the communications network 110. The communications network 110 may include connections, such as wire, wireless communication links, or fiber optic cables. As will be discussed with reference to FIG. 4, server computer 112 may include internal components 800a and external components 900a, respectively and client computer 102 may include internal components 800b and external components 900b, respectively. Client computer 102 may be, for example, a mobile device, a telephone, a personal digital assistant, a netbook, a laptop computer, a tablet computer, a desktop computer, or any type of computing device capable of running a program and accessing a network. According to various implementations of the present embodiment, the condition-based communication program 108A, 108B may interact with a database 116 that may be embedded in various storage devices, such as, but not limited to a mobile device 102, a networked server 112, or a cloud storage service.

According to the present embodiment, a program, such as a condition-based communication program 108A and 108B may run on the client computer 102 or on the server computer 112 via a communications network 110. The condition-based communication program 108A, 108B may initiate online communication groups, and enable users to discover and join the online communication groups based on conditions. For example, a user using a computer, such as computer 102, may run a condition-based communication program 108A, 108B, that interacts with a database 116, to initiate online communication groups based on conditions associated with real-time user data and enable users to discover the online communication groups by inputting conditions.

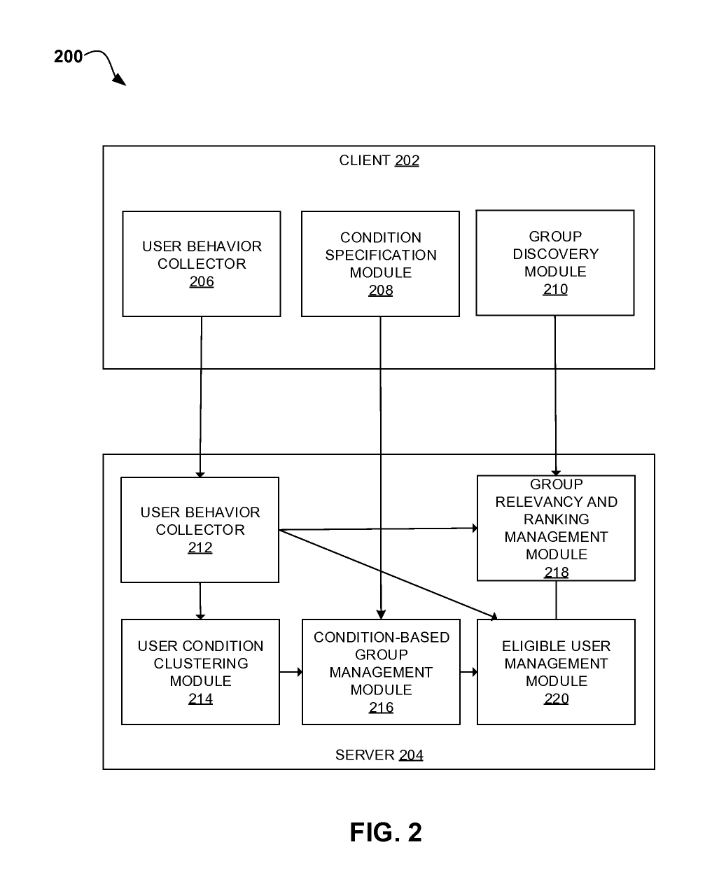

Referring now to FIG. 2, a block diagram 200 illustrating the system architecture of a program for generating and discovering online communication groups based on at least one condition is depicted. According to one implementation, a client computer 202 and a server 204 may run a condition-based communication program 108A, 108B (FIG. 1). Furthermore, according to one implementation, the condition-based communication program 108A, 108B (FIG. 1) may collect user real-time data associated with users on a user behavior collector 206. Then, the condition-based communication program 108A, 108B (FIG. 1) may send the collected user real-time data from the user behavior collector 206 on the client computer 202 to the user behavior collector 212 on the server 204. Next, the condition-based communication program 108A, 108B (FIG. 1) may enable user-initiated online communication groups and program-initiated online communication groups based on conditions associated with the collected user real-time data.

Specifically, for user-initiated online group communications, the condition-based communication program 108A, 108B (FIG. 1) may enable users to initiate online communication groups by using a condition specification module 208 to specify the conditions for discovering and joining the online communication groups. Additionally, for program-initiated online communication groups, the condition-based communication program 108A, 108B (FIG. 1) may use a condition clustering module 214 to initiate the online communication groups by clustering conditions associated with the collected user real-time data. Then, the condition-based communication program 108A, 108B (FIG. 1) may receive the specified conditions as well as the clustered conditions on the condition-based group management module 216 to create the condition-based online communication groups. Thereafter, the condition-based communication program 108A, 108B (FIG. 1) may use an eligible users management module 220 to find users eligible for the created condition-based online communication groups. Furthermore, the eligible users management module 220 may provide a list of the condition-based online communication groups to each eligible user. Additionally, the condition-based communication program 108A, 108B (FIG. 1) may calculate and rank the list of condition-based online communication groups using the group relevancy and ranking management module 218. Furthermore, the condition-based communication program 108A, 108B (FIG. 1) may enable eligible users to discover the condition-based online communication groups using a group discovery module 210.

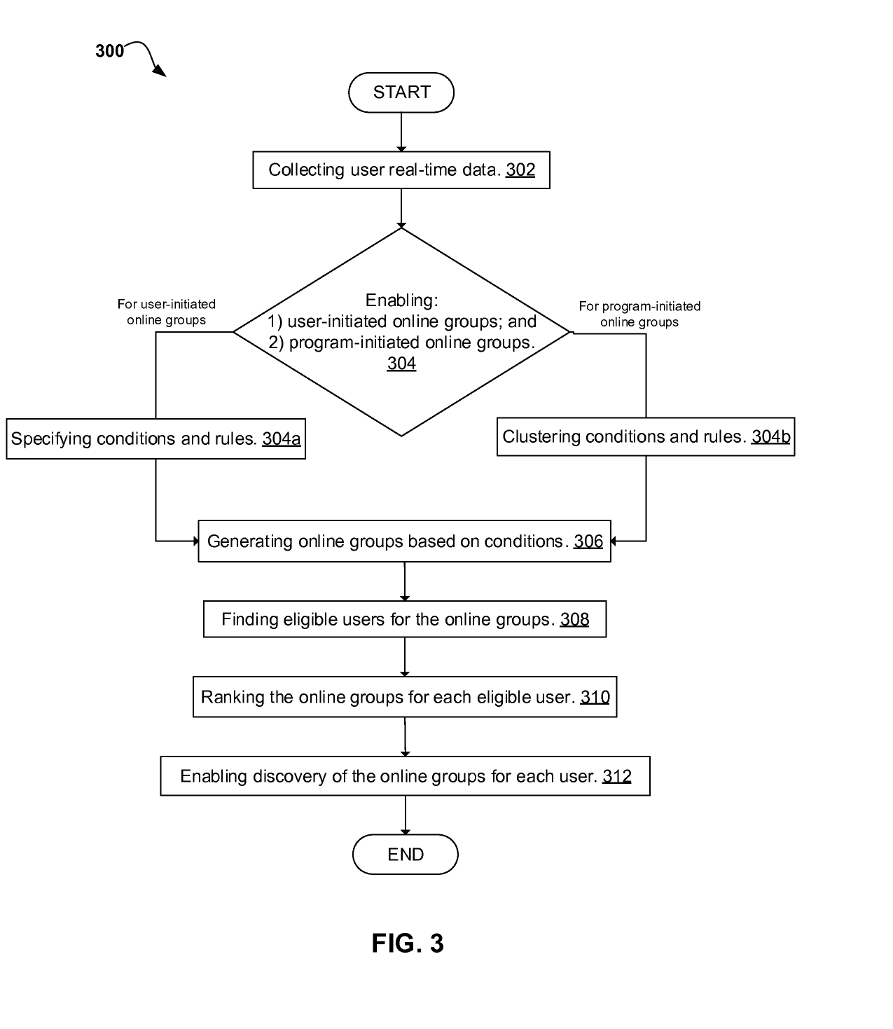

Referring now to FIG. 3, an operational flowchart 300 illustrating the steps carried out by a program for generating and discovering online communication groups based on at least one condition is depicted. At 302, the condition-based communication program 108A, 108B (FIG. 1) may collect user real-time data. As previously described in FIG. 2, the condition-based communication program 108A, 108B (FIG. 1) may use the user behavior collector 206 (FIG. 2) to collect user real-time data associated with users. Furthermore, the amount of user real-time data collected may depend on the user real-time data that is made available by the client service provider. For example, the collected user real-time data may include, but is not limited to, user GPS location, user web search history, user profiles, user download history, user apps usage, and user music history. Then, the condition-based communication program 108A, 108B (FIG. 1) may send the user real-time data collected on the user behavior collector 206 (FIG. 2) to the user behavior collector 212 (FIG. 2) on the server 204 (FIG. 2).

Then, at 304, the condition-based communication program 108A, 108B (FIG. 1) may enable user-initiated online communication groups and program-initiated online communication groups. As previously described in FIG. 2, user-initiated online communication groups may be enabled by users using the condition specification module 208 (FIG. 2) to specify conditions for the online communication groups. Therefore, at step 304a, users may initiate online communication groups by specifying a combination of conditions and rules associated with the collected user real-time data. Specifically, the condition-based communication program 108A, 108B (FIG. 1) may enable users to specify conditions that may determine the eligible users for the online communication groups. For example, the condition-based communication program 108A, 108B (FIG. 1) may enable a user to specify conditions such as specifying that an online communication group is for users of certain ages, for users in certain locations, for users of certain occupations, for users that are fans of certain sports and teams, for users that are interested in a certain genre of music, and/or for users that visit certain webpages.

Furthermore, at 304a, the condition-based communication program 108A, 108B (FIG. 1) may enable users to also specify rules for matching the users to the specified conditions. Specifically, the condition-based communication program 108A, 108B (FIG. 1) may enable users to specify whether individuals must fully match the specified conditions or may partially match the specified conditions. Additionally, the condition-based communication program 108A, 108B (FIG. 1) may enable users to specify that certain specified conditions must be fully matched while other specified conditions may be partially matched. Specifically, for partially matching conditions, the condition-based communication program 108A, 108B (FIG. 1) may determine that certain conditions may be optionally matched by individuals, and/or that the boundaries of certain conditions may be extended to include individuals not exactly matching the conditions but have similar conditions. Also, the condition-based communication program 108A, 108B (FIG. 1) may enable users to specify whether the conditions inputted by individuals searching for the online communication groups must fully match and/or partially match the specified conditions for the online communication groups.

For example, the condition-based communication program 108A, 108B (FIG. 1) may enable users to specify age conditions and location-based conditions for discovering and participating in the user-initiated online communication group. The condition-based communication program 108A, 108B (FIG. 1) may further enable users to specify that individuals inputting certain conditions, that may partially match the specified age and location-based conditions for the online communication group, may discover and join the online communication group. Alternatively, the condition-based communication program 108A, 108B (FIG. 1) may enable users to specify that participants must fully match the specified age conditions, but may partially match the specified location-based conditions.

Furthermore, at step 304b, the condition-based communication program 108A, 108B (FIG. 1) may cluster conditions for program-initiated online communication groups. As previously described in FIG. 2, program-initiated online communication groups may be enabled by the condition-based communication program 108A, 108B (FIG. 1) by using the user condition clustering module 214 (FIG. 2) to cluster conditions based on the collected user real-time data. For example, based on the collected user real-time data, the condition-based communication program 108A, 108B (FIG. 1) may discover that individuals gather at a certain location and during a certain time, and therefore, may cluster such conditions and initiate an online communication group based on the clustered location and time conditions. Furthermore, the condition-based communication program 108A, 108B (FIG. 1) may determine the rules for individuals matching the conditions. Specifically, a server-side algorithm may fully and partially match individuals to the conditions. For example, the condition-based communication program 108A, 108B (FIG. 1) may find that the amount of individuals matching the conditions may be lacking, and therefore, may match individuals located near the area and/or partially matching the time condition.

Next, at 306, the condition-based communication program 108A, 108B (FIG. 1) may generate the online communication groups based on the received conditions. As previously described in FIG. 2, the condition-based communication program 108A, 108B (FIG. 1) may receive the specified conditions as well as the clustered conditions on the condition-based group management module 216 (FIG. 2) to generate the condition-based online communication groups. Therefore, for user-initiated online communication groups, the specified conditions may be received by the condition-based group management module 216 (FIG. 2) via the client condition specification module 208 (FIG. 2). Additionally, for program-initiated online communication groups, the clustered conditions may be received by the condition-based group management module 216 (FIG. 2) via the user condition clustering module 214 (FIG. 2) on the server 204 (FIG. 2). As such, based on the received specified conditions and the received clustered conditions, the condition-based communication program 108A, 108B (FIG. 1) may generate the condition-based online communications groups using the condition-based group management module 216 (FIG. 2).

Then, at 308, the condition-based communication program 108A, 108B (FIG. 1) may find eligible users for the generated online communication groups. As previously described in FIG. 2, the condition-based communication program 108A, 108B (FIG. 1) may use the eligible users management module 220 (FIG. 2) to find users eligible for the generated condition-based online communication groups. Furthermore, the eligible users management module 220 (FIG. 2) may provide a list of the condition-based online communication groups to each eligible user. For example, the condition-based communication program 108A, 108B (FIG. 1) may generate a user-initiated condition-based online communication group that may include the conditions that each participant is located in a certain geographical area and interested in a certain genre of music, and the rule that participants may partially match the geographical area but must fully match the certain genre of music. Thus, based on the user real-time data collected on users by the user behavior collector 206, 212 (FIG. 2), the condition-based communication program 108A, 108B (FIG. 1) may find eligible users matching the rules and conditions for the online communication group.

Next, at 310, the condition-based communication program 108A, 108B (FIG. 1) may rank the online communication groups for each eligible user. As previously described in FIG. 2, the condition-based communication program 108A, 108B (FIG. 1) may calculate and rank the listed condition-based online communication groups using the group relevancy and ranking management module 218 (FIG. 2). Specifically, the condition-based communication program 108A, 108B (FIG. 1) may rank the list of condition-based online communication groups by using a server-side algorithm associated with the group relevancy and ranking management module 218 (FIG. 2). Furthermore, the group relevancy and ranking management module 218 (FIG. 2) may rank the online communication groups based on factors such as, but not limited to, the group conditions, whether users fully and/or partially match the group conditions, the amount of group conditions matching the users, the amount of participants in the online communication group, the amount of online communication groups that the user wants to view in the list, and how well the existing participants of the online communication group like the group. For example, based on the collected user real-time data and the received group conditions, the amount of the online communication groups may be substantial for certain users. As such, the condition-based communication program 108A, 108B (FIG. 1) may rank the list of online communication groups by calculating the relevancy of each online communication group to the users based on the collected user real-time data. Therefore, the group relevancy and ranking management module 218 (FIG. 2) may find that a user is interested in a certain topic based on the user's internet search history, and thus, provide a list of the eligible online communication groups beginning with the online communication groups related to the certain topic associated with the user's internet search history.

Next, at 312, the condition-based communication program 108A, 108B (FIG. 1) may enable discovery of the online communication groups. As previously described in FIG. 2, the condition-based communication program 108A, 108B (FIG. 1) may enable eligible users to discover the condition-based online communication groups by using the group discovery module 210 (FIG. 2). Therefore, based on the collected user real-time data, the condition-based communication program 108A, 108B (FIG. 1) may match eligible users to the online communication groups, rank the online communication groups based on the collected user real-time data, and provide a list of the ranked online communication groups to the eligible users. Additionally, the condition-based communication program 108A, 108B (FIG. 1) may enable users to discover certain online communication groups. Specifically, users may input conditions, find the online communication groups that match the users' inputted conditions, and then view the list of matching online communication groups and choose to join. Thus, users may specify the conditions the condition-based communication program 108A, 108B (FIG. 1) may use to match the users to the online communication groups.

For example, the condition-based communication program 108A, 108B (FIG. 1) may use location data and personal profile data to match users to the online communication groups, but users may specify that the location data and some of the personal profile data, such as gender and/or age, may not be used by the condition-based communication program 108A, 108B (FIG. 1) to match the users to the online communication groups. Furthermore, the condition-based communication program 108A, 108B (FIG. 1) may also enable users to specify whether to receive a list of online communication groups that the user exactly matches based on the inputted conditions, whether to receive the online communication groups that the user partially matches based on the inputted conditions, and to input the amount of online communication groups that the users want to view in the list of online communication groups. Thereafter, the condition-based communication program 108A, 108B (FIG. 1) may further enable users to join the online communication groups that the users are eligible for.

It may be appreciated that FIGS. 2-3 provide only an illustration of one implementation and does not imply any limitations with regard to how different embodiments may be implemented. Many modifications to the depicted environments may be made based on design and implementation requirements. For example, the condition-based communication program 108A, 108B (FIG. 1) may run on a software program 114 (FIG. 1), such as Firefox® (Firefox and all Firefox-based trademarks and logos are trademarks or registered trademarks of Mozilla and/or its affiliates), that interacts with a database 116 (FIG. 1), to enable users to initiate, discover and join online communication groups. Furthermore, the condition-based communication program 108A, 108B (FIG. 1) may enable users to specify security controls for the online communication groups, such as whether approval is needed from the online communication group initiator for users to join the online communication group. Also, the condition-based communication program 108A, 108B (FIG. 1) may enable users to join as anonymous members. Additionally, the condition-based communication program 108A, 108B (FIG. 1) may be in the form of, but not limited, a text, audio, video, a chat room, and a social network service (SNS).

FIG. 4 is a block diagram 400 of internal and external components of computers depicted in FIG. 1 in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 800 a, b and external components 900 a, b illustrated in FIG. 4. Each of the sets of internal components 800 a, b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828, the software program 114 (FIG. 1), the condition-based communication program 108A (FIG. 1) in client computer 102 (FIG. 1), and the condition-based communication program 108B (FIG. 1) in network server computer 112 (FIG. 1) are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, also includes a R/W drive or interface 832 to read from and write to one or more portable computer-readable tangible storage devices 936 such as a CD-ROM, DVD, memory stick, magnetic tape, magnetic disk, optical disk or semiconductor storage device. A software program, such as condition-based communication program 108A and 108B (FIG. 1), can be stored on one or more of the respective portable computer-readable tangible storage devices 936, read via the respective R/W drive or interface 832 and loaded into the respective hard drive 830.

Each set of internal components 800 a, b also includes network adapters or interfaces 836 such as a TCP/IP adapter cards, wireless Wi-Fi interface cards, or 3G or 4G wireless interface cards or other wired or wireless communication links. The condition-based communication program 108A (FIG. 1) and software program 114 (FIG. 1) in client computer 102 (FIG. 1), and condition-based communication program 108B (FIG. 1) in network server 112 (FIG. 1) can be downloaded to client computer 102 (FIG. 1) from an external computer via a network (for example, the Internet, a local area network or other, wide area network) and respective network adapters or interfaces 836. From the network adapters or interfaces 836, the condition-based communication program 108A (FIG. 1) and software program 114 (FIG. 1) in client computer 102 (FIG. 1) and the condition-based communication program 108B (FIG. 1) in network server computer 112 (FIG. 1) are loaded into the respective hard drive 830. The network may comprise copper wires, optical fibers, wireless transmission, routers, firewalls, switches, gateway computers and/or edge servers.

Each of the sets of external components 900 a, b can include a computer display monitor 920, a keyboard 930, and a computer mouse 934. External components 900 a, b can also include touch screens, virtual keyboards, touch pads, pointing devices, and other human interface devices. Each of the sets of internal components 800 a, b also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

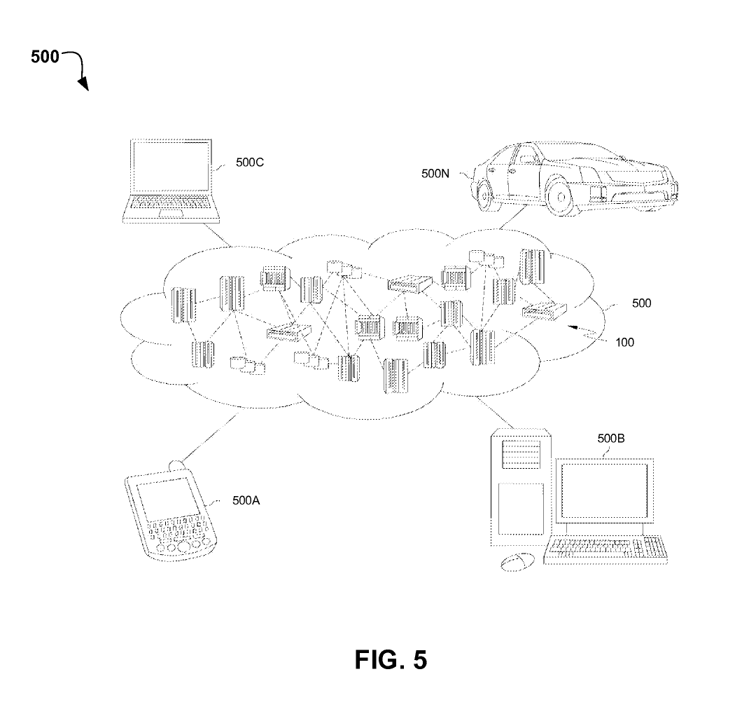

Referring now to FIG. 5, illustrative cloud computing environment 500 is depicted. As shown, cloud computing environment 500 comprises one or more cloud computing nodes 100 with which local computing devices used by cloud consumers, such as, for example, personal digital assistant (PDA) or cellular telephone 500A, desktop computer 500B, laptop computer 500C, and/or automobile computer system 500N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 500 to offer infrastructure, platforms and/or software as services for which a cloud consumer does not need to maintain resources on a local computing device. It is understood that the types of computing devices 500A-N shown in FIG. 5 are intended to be illustrative only and that computing nodes 100 and cloud computing environment 500 can communicate with any type of computerized device over any type of network and/or network addressable connection (e.g., using a web browser).

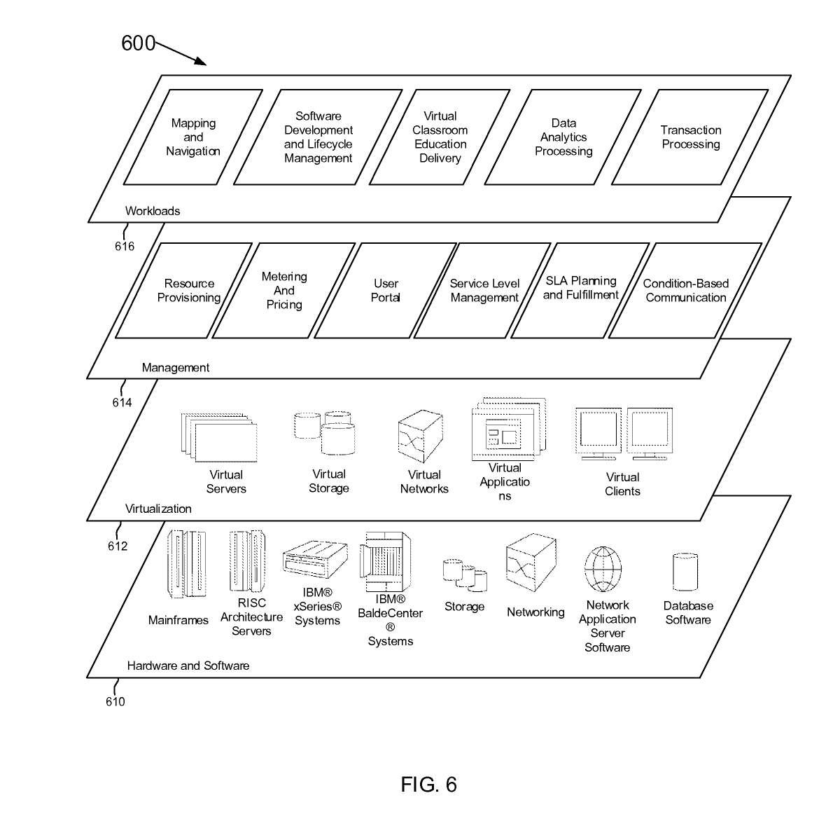

Referring now to FIG. 6, a set of functional abstraction layers 600 provided by cloud computing environment 500 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 610 includes hardware and software components. Examples of hardware components include: mainframes; RISC (Reduced Instruction Set Computer) architecture based servers; storage devices; networks and networking components. In some embodiments, software components include network application server software.

Virtualization layer 612 provides an abstraction layer from which the following examples of virtual entities may be provided: virtual servers; virtual storage; virtual networks, including virtual private networks; virtual applications and operating systems; and virtual clients.

In one example, management layer 614 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA. A Condition-Based Communication program may generate online communication groups, and enable users to discover and join the online communication groups based on conditions.

Workloads layer 616 provides examples of functionality for which the cloud computing environment may be utilized. Examples of workloads and functions which may be provided from this layer include: mapping and navigation; software development and lifecycle management; virtual classroom education delivery; data analytics processing; and transaction processing.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1.-7. (canceled)

8. A computer system for generating and discovering a plurality of online communication groups based on at least one condition, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
collecting a plurality of user real-time data;
initiating a plurality of first online communication groups, wherein a user is enabled to specify a plurality of conditions associated with the collected plurality of user real-time data;
applying the plurality of specified conditions to the plurality of first online communication groups;
initiating a plurality of second online communication groups;
clustering a plurality of conditions associated with the collected user real-time data, wherein the plurality of clustered conditions are applied to the plurality of second online communication groups;
generating the plurality of first online communication groups based on the plurality of specified conditions;
generating the plurality of second online communication groups based on the plurality of clustered conditions; and
enabling user discovery of the plurality of first online communication groups and the plurality of second online communication groups, wherein the user discovery is based on whether the user matches the plurality of specified conditions and the plurality of clustered conditions associated with the collected user real-time data.

9. The computer system of claim 8, wherein the collected user real-time data comprises a user GPS location, a user web search history, a user profile, a user download history, a user apps usage, and a user music history.

10. The computer system of claim 9, further comprising:
associating a plurality of rules with the plurality of specified conditions and the plurality of clustered conditions based on the collected user real-time data.

11. The computer system of claim 10, wherein the plurality of rules determines whether a user fully matches, partially matches, or fully and partially match the plurality of specified conditions and the plurality of clustered conditions for the plurality of first online communication groups and the plurality of second online communication groups, respectively.

12. The computer system of claim 8, further comprising:
presenting a ranked list of the plurality of first online communication groups and the plurality of second online communication groups to the user based on the collected user real-time data.

13. The computer system of claim 8, wherein the user discovery of the plurality first online communication groups and the plurality of second online communication groups is based on detecting a plurality of conditions inputted by the user that match the plurality of specified conditions and the plurality of clustered conditions.

14. The computer system of claim 8, wherein the plurality of first online communication groups and the plurality of second online communication groups enables communication via at least one of a text, an audio, a video, a chat room, and a social network service (SNS).

15. A computer program product for generating and discovering a plurality of online communication groups based on at least one condition, comprising:
one or more computer-readable storage devices and program instructions stored on at least one of the one or more tangible storage devices, the program instructions executable by a processor, the program instructions comprising:
program instructions to collect a plurality of user real-time data;
program instructions to initiate a plurality of first online communication groups, wherein a user is enabled to specify a plurality of conditions associated with the collected plurality of user real-time data;
program instructions to apply the plurality of specified conditions to the plurality of first online communication groups;
program instructions to initiate a plurality of second online communication groups;
program instructions to cluster a plurality of conditions associated with the collected user real-time data, wherein the plurality of clustered conditions are applied to the plurality of second online communication groups;
program instructions to generate the plurality of first online communication groups based on the plurality of specified conditions;
program instructions to generate the plurality of second online communication groups based on the plurality of clustered conditions; and
program instructions to enable user discovery of the plurality of first online communication groups and the plurality of second online communication groups, wherein the user discovery is based on whether the user matches the plurality of specified conditions and the plurality of clustered conditions associated with the collected user real-time data.

16. The computer program product of claim 15, wherein the collected user real-time data comprises a user GPS location, a user web search history, a user profile, a user download history, a user apps usage, and a user music history.

17. The computer program product of claim 15, further comprising:
program instructions to associate a plurality of rules with the plurality of specified conditions and the plurality of clustered conditions based on the collected user real-time data, wherein the plurality of rules determines whether a user fully matches, partially matches, or fully and partially match the plurality of specified conditions and the plurality of clustered conditions for the plurality of first online communication groups and the plurality of second online communication groups, respectively.

18. The computer program product of claim 15, further comprising:
program instructions to present a ranked list of the plurality of first online communication groups and the plurality of second online communication groups to the user based on the collected user real-time data.

19. The computer program product of claim 15, wherein the user discovery of the plurality first online communication groups and the plurality of second online communication groups is based on detecting a plurality of conditions inputted by the user that match the plurality of specified conditions and the plurality of clustered conditions.

20. The computer program product of claim 15, wherein the plurality of first online communication groups and the plurality of second online communication groups enables communication via at least one of a text, an audio, a video, a chat room, and a social network service (SNS).
